(19) United States
(12) Patent Application Publication
(10) Pub. No.: US 2007/0274752 A1
(43) Pub. Date: Nov. 29, 2007

(54) Image Forming Apparatus

(76) Inventor: Kazuaki Imaizumi, Ibaraki (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/573,430

(22) PCT Filed: Sep. 17, 2004
(86) PCT No.: PCT/JP04/13685

§ 371 Date: Feb. 22, 2007

(30) Foreign Application Priority Data
Sep. 24, 2003 (JP) 2003-332487

(51) Int. Cl. G03G 15/00

(52) U.S. Cl. 399/388

(57) ABSTRACT

In a supplementary paper feed device 20 for feeding a recording medium P fed from the outside through a paper feed opening portion 202 provided in an apparatus main unit into a paper feed conveying path 132 of a main paper feed device 13, a paper conveying path 201 extending from the above-described paper feed opening portion 202 to the paper feed conveying path 132 is formed to reflect ambient light A entered from the above-described paper feed opening portion 202 in a direction except for a direction toward an image carrier or block the ambient light A, so that an excellent image can be obtained by preventing disturbance of a latent image written on the image carrier due to the above-described ambient light A. As a result, an image with high quality can be obtained with a simple constitution.

### TECHNICAL FIELD

The present invention relates to an image forming apparatus where a paper feed opening portion for conveying a recording medium is provided in an apparatus main unit.

### BACKGROUND ART

Generally, in various image forming apparatuses such as an electrophotographic copying machine or a printer, a paper feed device constituted of a paper feed cassette on which many recording mediums can be stacked, and the like is disposed, and a recording medium fed from the paper feed device is conveyed through a fed paper conveying path so that it is fed into a transfer region of an image carrier such as a photosensitive drum on which an electrostatic latent image is formed.

In such a paper feed device, especially, a paper feed opening portion which is opened to an apparatus main unit for the purpose of feeding a special recording medium such as a cardboard, a postcard, or an envelope, except for normal recording papers can be provided. The paper feed opening portion can be secondarily provided to a main paper feed device or it can be provided alone, and a recording medium fed into the apparatus main unit through a paper conveying path in the paper feed opening portion is fed into the above-described paper feed conveying path to be conveyed to the above-described transfer region.

### DISCLOSURE OF THE INVENTION

### Problem to be Solved by the Invention

However, such a path from the paper feed opening portion to the image carrier is frequency formed in a approximately linear simple shape, where ambient light entering from the paper feed opening portion to an apparatus inside may be reflected by a surface of the paper conveying path to reach the image carrier. The reflected light is irradiated on a surface of the image carrier so that a potential of an original latent image written on the image carrier or a surrounding region thereof is changed, which may result in considerable deterioration of image quality due to adhesion of useless toner to an image region or a region thereabout.

In order to solve such a problem, it has been conventionally conducted to arrange another member such as a light shielding sheet for shielding the image carrier from reflected light from a surface of a paper conveying path extending from the paper feed opening portion, or change and optimize a part arrangement inside the apparatus main unit, to prevent the above-described reflected light from reaching the image carrier as much as possible. However, when another member such as the light shielding sheet is arranged, a sufficient light-shielding effect can not be obtained due to a spatial restraint inside the apparatus main unit, and such a problem arises that the number of parts increases, which results in product cost increase. Further, even if the optimization is achieved by changing the part arrangement inside the apparatus main unit, unless reflected light on the paper conveying path extending from the paper feed opening portion is shielded, reflected light reaching the image carrier can not be prevented sufficiently.

In view of these circumstances, an object of the present invention is to provide an image forming apparatus where the image carrier is excellently shielded from reflected light of ambient light entering from a paper feed opening portion with a simple constitution and an image with high quality can be obtained.

### Means for Solving the Problem

In order to achieve the above object, an image forming apparatus of the present invention described in claim 1 is an image forming apparatus where a paper feed opening portion for feeding a recording medium toward a transfer region of an image carrier formed with an electrostatic latent image is provided in an apparatus main unit, wherein a paper conveying path face extending from the paper feed opening portion to the transfer region is formed of an inclined face set to such an angle that ambient light entering inside the apparatus main unit through the paper feed opening portion is reflected in a direction except for a direction toward the image carrier.

According to the image forming apparatus of the present invention having such a constitution described in claim 1, even if ambient light enters from the paper feed opening portion to the inside of the apparatus, reflected light reflected on the paper conveying path surface constituted of the inclined face extending from the paper feed opening portion advances in a direction except for a direction of the image carrier so as to avoid the image carrier. As a result, an image with high quality can be easily and reliably obtained without changing a potential of the latent image or a potential of a region surrounding the image.

Further, in an image forming apparatus of the present invention described in claim 2, the inclined face forming the paper conveying path face described in claim 1 is constituted of a flat face or a plurality of undulated faces.

According to the image forming apparatus of the present invention having such a constitution described in claim 2, the above-described function can be reliably obtained by a simple structure where the paper conveying face itself extending from the paper feed opening portion is formed properly.

Furthermore, an image forming apparatus of the present invention described in claim 3 is an image forming apparatus where a paper feed opening portion for feeding a recording medium toward a transfer region of an image carrier formed with an electrostatic latent image is provided in an apparatus main unit, wherein a paper conveying path extending from the paper feed opening portion to the transfer region is constituted of a plurality of thin plate-like partition plates arranged at proper intervals along a direction perpendicular to a paper conveying direction, and a light shielding plate for shielding the image carrier from ambient light entered from the paper feed opening portion in interior of the apparatus is provided in a space between the thin plate-like partition plates adjacent to each other in the direction of the arrangement of the thin plate-like partition plates.

According to the image forming apparatus of the present invention having such a constitution described in claim 3, even if ambient light enters from the paper feed opening portion inside the apparatus, most of ambient light is blocked by the light shielding plates formed among the plurality of thin plate-like partition plates constituting the paper conveying path extending from the paper feed opening portion, so that only reflected light from slight areas of the paper conveying face formed on edge portions of the thin plate-like partition plates is irradiated on the image carrier. Accordingly, a light amount of reflected light irradiated on the image carrier is reduced largely as compared with the conventional apparatus, disturbance to a latent image written on the image carrier due to the above-described ambient light is prevented excellently, and sliding resistance of a recording medium on the paper conveying path due to the thin plate-like partition plates or stress acting on a leading end of a paper can be reduced, so that an image with high quality can be obtained.

### Effect of the Invention

As described above, in the image forming apparatus of the present invention described in claim 1, since the paper conveying face extending to the transfer region from the paper feed opening portion for feeding a recording medium to be fed from the outside through the paper feed opening portion provided in the apparatus main unit to the transfer region is formed by the inclined face for reflecting ambient light entering from the paper feed opening portion in a direction except for a direction toward the image carrier, disturbance to a latent image written on the image carrier due to the above-described ambient light is prevented from occurring and an excellent image can be obtained. So that an image with high quality can be obtained with a simple constitution and reliability of an image forming apparatus can be improved significantly with a low cost.

Further, in the image forming apparatus of the present invention described in claim 2, since the inclined face forming the paper conveying face described in claim 1 is constituted of a flat face or a plurality of undulated faces, an excellent image can be obtained with a simple structure where a face constitution for the paper conveying path extending from the paper feed opening portion is formed properly, so that productivity of an apparatus can be improved in addition to the above described effect.

Furthermore, in the image forming apparatus of the present invention described in claim 3, since the paper conveying path extending to the transfer region from the paper feed opening portion for feeding a recording medium to be fed from the outside through the paper feed opening portion provided in the apparatus main unit to the transfer region is constituted of the plurality of thin plate-like partition plates arranged at proper intervals in a direction perpendicular to a paper conveying direction, and the light shielding plate for shielding the image carrier from ambient light entering from the paper feed opening portion are provided between the thin plate-like partition plates adjacent to each other, most of ambient light entering inside the apparatus from the paper feed opening portion is blocked to the image carrier and an excellent image can be obtained by blocking disturbance to a latent image written on the image carrier due to the above-described ambient light, so that an image with high quality can be obtained with a simple constitution and reliability of an image forming apparatus can be improved largely with a low cost.

### BRIEF DESCRIPTION OF THE DRAWINGS

FIG. 1 is a schematic vertical sectional explanatory view showing an internal structure of a printer according to an embodiment of the present invention;

FIG. 2 is a schematic vertical sectional explanatory view showing a structure of a supplementary paper feed device in the printer shown in FIG. 1 in an enlarged manner;

FIG. 3 is a schematic vertical sectional explanatory view showing an internal structure of a printer according to another embodiment of the present invention;

FIG. 4 is a schematic vertical sectional explanatory view showing a structure of a supplementary paper feed device in the printer shown in FIG. 3;

FIG. 5 is a schematic vertical sectional explanatory view showing an internal structure of a printer according to still another embodiment of the present invention;

FIG. 6 is a schematic vertical sectional explanatory view showing an internal structure of a printer according to still another embodiment of the present invention;

FIG. 7 is an appearance perspective explanatory view showing one portion of a paper conveying path in a supplementary paper feed device shown in FIG. 6 in an enlarging manner; and

FIG. 8 is a side explanatory view of the paper conveying path of the supplementary paper feed device shown in FIG. 7.

### BEST MODE FOR CARRYING OUT THE INVENTION

Embodiments of the present invention will be explained below in detail with reference to the drawings. Prior to the explanation, a whole structure of an image forming apparatus will be outlined utilizing a laser printer as one example.

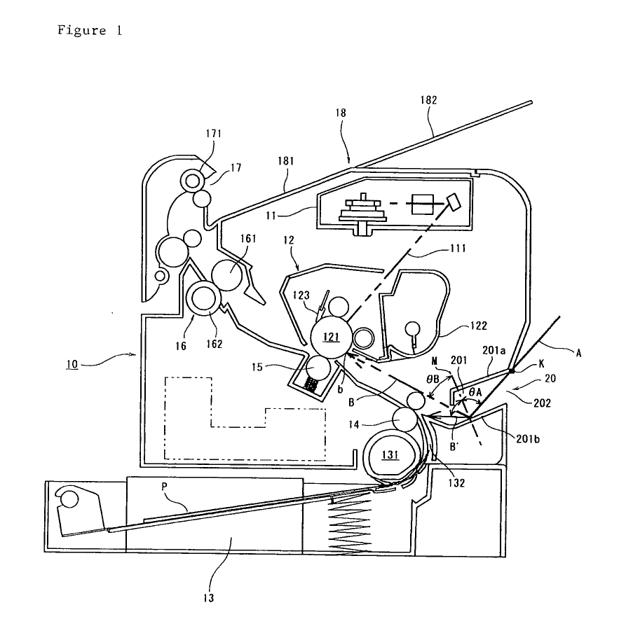

In a laser printer 10 shown in FIG. 1, for example, image information sent from an external computer is focused in a spot shape on a photosensitive drum 121 serving as an image carrier and provided inside a process cartridge 12 as optical modulation information 111 by a laser light emitting writing portion 11 via a video controller (not shown), and a light spot is scanned in an axial direction (a main scanning direction) of the photosensitive drum 121 in a reciprocating manner so that an electrostatic latent image corresponding to an image to be formed is formed on the photosensitive drum 121. Then, developer (toner) is supplied to the electrostatic latent image on the photosensitive drum 121 from a developing device 122 integrally provided inside the process cartridge 12 so that a non-fused toner image is formed.

On the other hand, a paper feed cassette 13 constituting a main paper feed unit is disposed in a lower portion of the apparatus. Recording papers (recording mediums) P with a desired size are stored in the paper feed cassette 13 in a stacking manner. Then, a recording paper P in the paper feed cassette 13 is drawn out according to rotation of a paper feed roller 131 to be fed into a fed paper conveying path 132 reaching a transfer region facing the above-described photosensitive drum 121, and it is conveyed toward the above-described transfer region while it is being timed properly by a registration roller 14 provided on the fed paper conveying path 132.

A transfer roller 15 serving as a contact transfer member is arranged in the transfer region of the photosensitive drum 121 in a contacting manner so as to contact with a surface of the photosensitive drum 121. A transfer bias is applied to the transfer roller 15 and a non-fused toner image on the above-described photosensitive drum 121 is electrostatically transferred on a recording paper P by the transfer bias. Further, after transferred, toner remaining on the above-described photosensitive drum 121 is scrapped off by a sliding force of a cleaning blade 123 disposed so as to pressure-contact with the surface of the photosensitive drum 121.

Moreover, the recording paper P carrying the non-fused toner owing to the above-described transfer force is conveyed toward a fusing device 16 disposed adjacent to the above-described process cartridge 12. A fusing roller 161 serving as a heater and a pressurizing roller 162 are provided in the above-described fusing device 16, and the non-fused toner on the above-described recording paper P is headed and fused according to a heating and fusing operation of the fusing roller 161 and the pressurizing roller 162, so that the toner image is fixed and fused on the above-described recording paper P. The recording paper P with the toner image fixed by such heating and fusing operation is discharged on a paper discharge tray 18 by a paper discharge roller 171 at a paper discharge port 17 provided on an upper portion side of the apparatus main unit shown in FIG. 1.

The paper discharge tray 18 is for holding recording papers P discharged after fused in a stacking manner, and it is provided such that a fixed paper discharge tray 181 extends from a position just below the paper discharge port 17 of the apparatus main unit obliquely upwardly toward a paper feeding direction (in a rightward direction in FIG. 1) utilizing a portion of a cover of the apparatus main unit and a movable paper discharge tray 182 is coupled at a distal end of the fixed paper discharge tray 181 in the paper feeding direction thereof to be rotatable about a supporting pin. The movable paper discharge tray 182 is constituted to be opened and closed between an opened use position illustrated and a storing closed position (not shown), and a space above the fixed paper discharge tray 181 is opened and closed by the movable paper discharge tray 182.

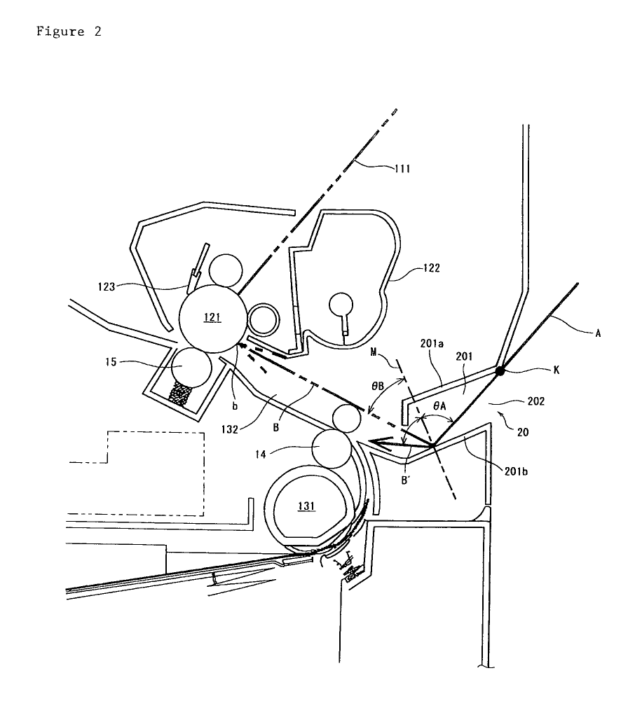

On the other hand, especially, as shown in FIG. 2, a paper conveying path 201 of a supplementary paper feed device 20 is connected to an intermediate position of a fed paper conveying path 132 extending from the above-described paper feed cassette 13 serving as the main paper feed device to the transfer region. The paper conveying path 201 of a supplementary paper feed device 20 is provided in a portion between an upper conveying plate 201a and a lower conveying plate 201b which are formed utilizing the cover of the apparatus main unit, it is formed to extend from a paper feed opening portion 202 provided to open to a surface side of the apparatus main unit into the apparatus to merge into a portion just before a registration roller 14 provided inside the above-described fed paper conveying path 132 in a paper feeding direction.

A paper conveying surface of the lower conveying plate 201b constituting a bottom face of the paper conveying path 201 is formed by utilizing an inclined face descending at a relatively steep angle from the above-described paper feed opening portion 202 toward the apparatus inside (on the left side in FIG. 2). An inclination angle of the inclined face forming the lower conveying plate 201b is set to such an angle as to reflect ambient light entered from the above-described paper feed opening portion 202 toward a member except for the photosensitive drum 121, where reflected light B of ambient light A in the lower conveying plate 201b is reflected toward a downward side (illustrated) deviated from the photosensitive drum 121.

That is, when a normal line at an arbitrary one point P on a conveying face on the lower conveying plate 201b in the above-described paper conveying path 201 is represented as M, a straight line passing through an arbitrary point K at an opening edge portion of the above-described paper feed opening portion 202 to reach the point P on the lower conveying plate 201b is represented as a straight line (ambient light) A, and a straight line connecting the point P on the above-described lower conveying plate 201b and an arbitrary point b on a surface of the photosensitive drum 121 is represented as a straight line (reflected light) B, a relationship between an angle θA formed by the straight line A and the normal line M and an angle θB formed by the straight line B and the normal line M is set to satisfy a relationship of θA>θB, and a constitution is constituted such that actual reflected light B′ reflected on a surface of the above-described paper conveying path 201 advances below the photosensitive drum 121.

According to the embodiment thus constituted, even if ambient light A enters from the above-described paper feed opening portion 202 to the apparatus inside, reflected light B′ reflected on the surface of the paper conveying path 201 extending from the paper feed opening portion 202 is not directed to the photosensitive drum 121 but it advances so as to avoid the photosensitive drum 121, which is different from reflected light B in the conventional apparatus. As a result, an image with high quality can be obtained easily and reliably without changing a potential of a latent image on the photosensitive drum 121 or a potential of a region around the same.

Incidentally, in the above-described embodiment, such a constitution is adopted that ambient light A entered from the paper feed opening portion 202 is reflected in a direction toward the illustrated lower side such that it is not irradiated on the photosensitive drum 121, but even if such an constitution that ambient light A entered from the paper feed opening portion 202 is reflected in a direction toward the illustrated upper side, namely, a constitution satisfying θA<θB is adopted, similar function and effect can be obtained.

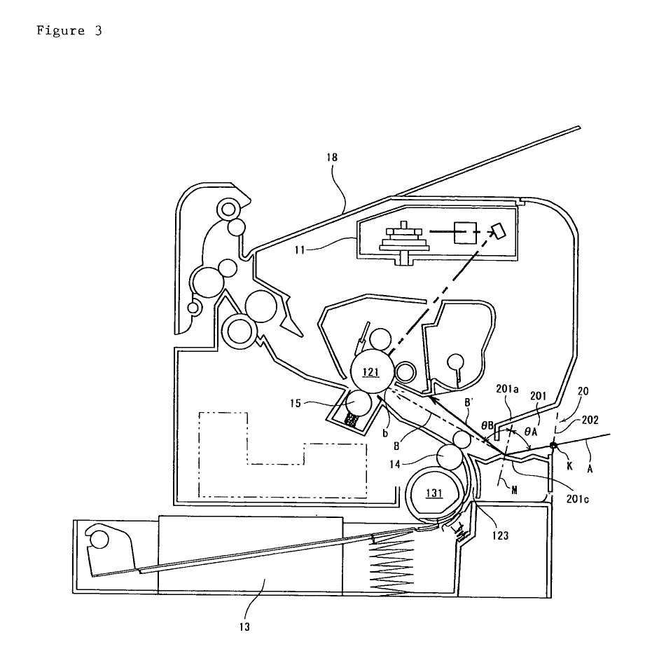

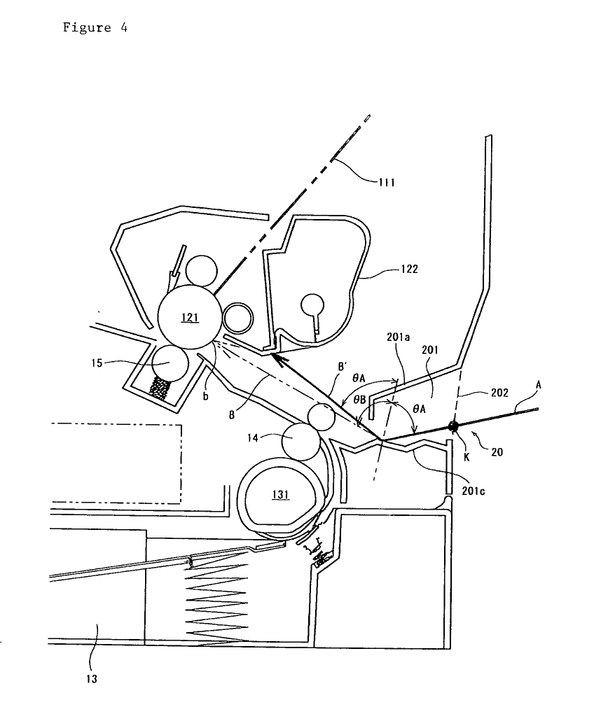

On the other hand, in a second embodiment shown in FIG. 3 and FIG. 4 where the same constituent members as those in the above-described embodiment are attached with the same reference numerals, a lower conveying plate 201c constituting a bottom face of the paper conveying path 201 extending from the paper feed opening portion 202 provided in the supplementary paper feed device 20 to the fed paper conveying path 132 is formed of a continuous member of a saw-like and triangular wave-shaped undulated inclined face extending in an advancing direction (in a leftward direction in FIG. 3 and FIG. 4) of ambient light A entered from the above-described paper feed opening portion 202. A surface side inclined face of respective inclined faces of the saw-like and triangular wave-shaped lower conveying plate 201c which faces the advancing direction of the above-described ambient light A is set to form such an inclination angle as to deviate reflected light B′ entering from the surface-side inclined face above the photosensitive drum 121, while a rear surface side inclined face in the advancing direction of the above-described ambient light A is set to such an inclination angle as to deviate reflected light entered from the rear surface side inclined face below the photosensitive drum 121. In the second embodiment having such a constitution, a function and an effect similar to those in the above-described first embodiment can be obtained.

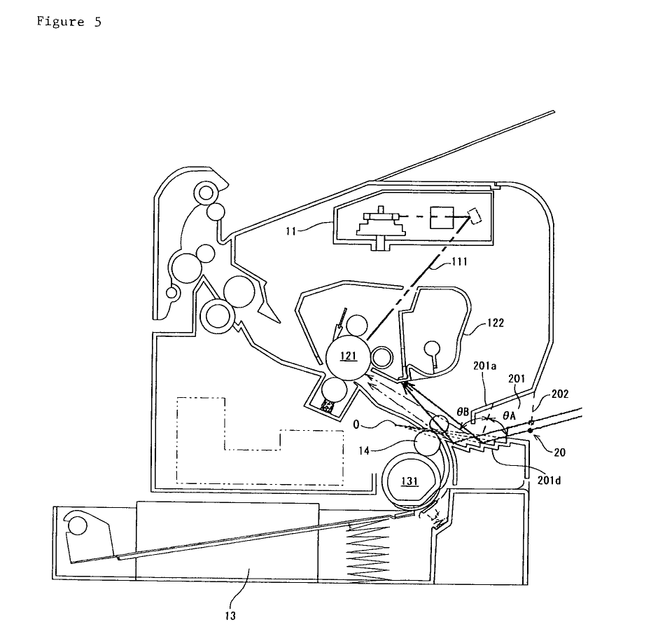

Further, in a third embodiment shown in FIG. 5 where the same constituent members as those in the above-described each embodiment are attached with the same reference numerals, a lower conveying plate 201d constituting a bottom face of the paper conveying path 201 extending from the paper feed opening portion 202 of the supplementary paper feed device 20 to the fed paper conveying path 132 extends in a stepped shape descending stepwise toward an advancing direction (in the leftward direction in FIG. 5) of ambient light A entered from the above-described paper feed opening portion 202.

An inclined face corresponding to a surface side of respective stepwise and step-shaped inclined faces in a advancing direction of the ambient light A is formed as a face contributing to reflection of the above-described ambient light A, and an angle setting is performed along a line extending from a converging point O properly set radially such that the inclined face contributing to the reflection constitutes a face for deviating the reflected light B above the photosensitive drum 121. In the third embodiment having such a constitution, a function and an effect similar to those in the above-described first embodiment can be obtained.

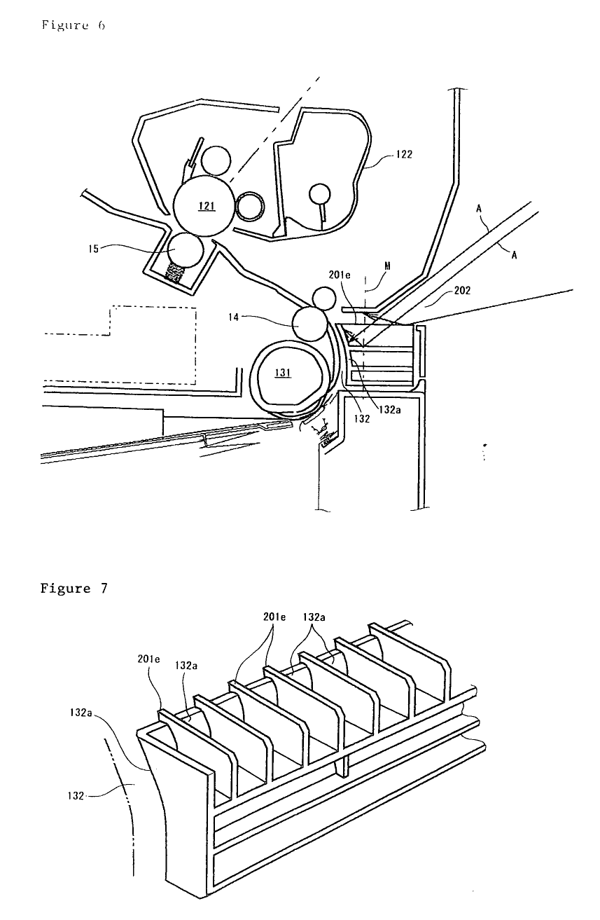

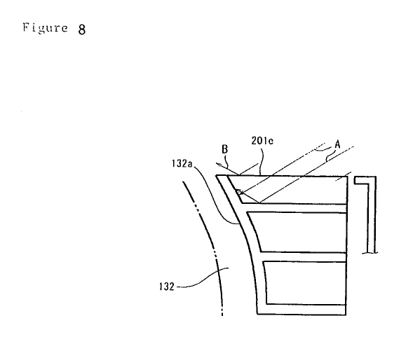

Furthermore, in a fourth embodiment shown in FIG. 6, FIG. 7, and FIG. 8 where the same constituent members as those in the above-described embodiments are attached with the same reference numerals, a lower side portion of the paper conveying path 201, that it, a lower conveying plate 201e of a portion facing an inlet port side of the above-described registration roller 14 is constituted of a plurality of thin plate-like partition plates arranged along a direction perpendicular to a paper conveying direction. The lower conveying plate 201e constituted of the thin plate-like partition plates is constituted to be erectly provided behind a main unit frame 132a constituted of a curved plate forming one portion of the fed paper conveying path 132 extending to the above-described transfer region.

That is, many thin plate-like partition plates 201e are mounted to the above-described main unit frame 132a in a rib manner in a direction perpendicular to the paper conveying direction at proper intervals, and such a constitution is adopted that a portion of the main unit frame 132a corresponding to a portion between the respective thin plate-like partition plates 201e forms a light shielding plate which shields the photosensitive drum 121 from ambient light A entered from the above-described paper feed opening portion 202.

At that time, when a recording medium to be conveyed is a thin paper with reduced rigidity. The conveying path is required to guide the recording medium formed of the thin paper while stress is prevented from acting on a leading end of the recording medium in the conveying direction. Therefore, it is desirable that an upper face shape of the above-described lower conveying plate 201e is formed in a straight shape or a moderate curved shape, but an upper end face of the thin plate-like partition plate 201e in the embodiment which guides a recording medium is formed in a straight line.

According to the fourth embodiment, even if ambient light A from the paper feed opening portion 202 enters in the apparatus interior, the paper conveying path constituted of the plurality of thin plate-like partition plates 201e is provided in a depth side of the paper feed opening portion 202, so that most of ambient light A is blocked by the light shielding plate 132a formed between the thin plate-like partition plates 201e and only reflected light B from slight areas formed at the upper edge portions of the thin plate-like partition plates 201e is irradiated on the photosensitive drum 121. Accordingly, a light amount of reflected light B irradiated on the photosensitive drum 121 is remarkably reduced as compared with that in the conventional art, so that disturbance on a latent image written on the photosensitive drum 121 and a region surrounding the same due to the above-described ambient light A is reduced significantly. Further, by constituting the lower conveying plate with the thin plate-like partition plates 201e, sliding resistance of the recording paper P is reduced and, especially, by using a straight lower conveying plate, stress at a leading end of the recording paper P can be reduced, so that an image with a considerably high quality can be obtained.

Though the embodiments of the present invention which has been made by the present inventor(s) have been specifically explained above, the present invention is not limited to the above embodiments, it goes without saying that it may be modified variously within a range departing from the gist of the present invention.

For example, in the above-described respective embodiments, the present invention has been applied to a printer, but the present invention is similarly applicable to another image forming apparatus such as a copying machine.

Further, in the above-described embodiments, the paper feed opening portion has been provided as the supplementary paper feed device to the main paper feed device, but the paper feed opening portion can be constituted as a single paper feed device instead of a plurality of paper feed devices.

### INDUSTRIAL APPLICABILITY

The above-described image forming apparatus according to the present invention can be widely applied to various image forming apparatus such as a copying machine, including such an image forming apparatus as a printer.

### EXPLANATION OF REFERENCE NUMERALS

10: Laser printer (Image forming apparatus)

12: Process cartridge

121: Photosensitive drum (Image carrier)

122: Developing device

13: Paper feed cassette (Main paper feed device)

131: Paper feed roller

132: Fed pafer conveying path

14: Registration roller

16: Fusing device

18: Paper discharge tray

P: Recording paper (Recording medium)

20: Supplementary paper feed device

201: Paper conveying path

202: Paper feed opening portion

201a: Upper conveying plate

201b: Lower conveying plate

201c: Lower conveying plate

201d: Lower conveying plate

201e: Lower conveying plate (Thin plate-like partition plate)

132a: Main unit frame (Light shielding plate)

1. An image forming apparatus where a paper feed opening portion for feeding a recording medium toward a transfer region of an image carrier formed with an electrostatic latent image is provided in an apparatus main unit, wherein
a paper conveying path face extending from the paper feed opening portion to the transfer region is formed of an inclined face set to such an angle that ambient light entering inside the apparatus main unit through the paper feed opening portion is reflected in a direction except for a direction toward the image carrier.

2. An image forming apparatus according to claim 1, wherein the inclined face forming the paper conveying path face is constituted of a flat face or a plurality of undulated faces.

3. An image forming apparatus where a paper feed opening portion for feeding a recording medium toward a transfer region of an image carrier formed with an electrostatic latent image is provided in an apparatus main unit, wherein
a paper conveying path extending from the paper feed opening portion to the transfer region is constituted of a plurality of thin plate-like partition plates arranged at proper intervals along a direction perpendicular to a paper conveying direction, and
a light shielding plate for shielding the image carrier from ambient light entered from the paper feed opening portion in interior of the apparatus is provided in a space between the thin plate-like partition plates adjacent to each other in the direction of the arrangement of the thin plate-like partition plates.
